(19) United States
(12) Patent Application Publication
(10) Pub. No.: US 2006/0216319 A1
(43) Pub. Date: Sep. 28, 2006

(54) Bioactive chemicals with increased activity and methods for making same

(76) Inventors: Andrew C. Chapple, Lagenfeld (DE); Robin A.J. Taylor, Wooster, OH (US)

Correspondence Address: JEANNE E. LONGMUIR, 2836 CORYDON ROAD, CLEVELAND HEIGHTS, OH, 44118, US

(21) Appl. No.: 11/367,007

(22) Filed: Mar. 1, 2006

Related U.S. Application Data
(60) Provisional application No. 60/657,464, filed on Mar. 1, 2005.

(51) Int. Cl. A01N 25/00

(52) U.S. Cl. 424/405

(57) ABSTRACT

The present application provides improved bioactive chemicals having increased bioactive activity and a method for manufacturing such materials. The improved chemical material is provided with an optimum particle size or a small set of optimal particle sizes within the bioactive chemical material in order to obtain increased activity of the active ingredient. The use of an optimum particle size enables a reduction in the amount of active ingredient required in the bioactive chemical for a specified biological effect. The formulation comprises a bioactive material in particulate form in which at least 50% of the particles by volume or mass are in the range 0.5M to 1.5M, where M is the most biologically active particle size class or mode, and the number of particulate size classes is at least 12 and preferably at least 20, such that the particulate distribution can be characterized efficiently and the mode be well defined. In an alternate formulation, at least 90% of the bioactive material particles by volume or mass are in the range 0.5M to 1.5M, and 50% of the particles by volume or mass are in the range 0.75M to 1.25M. Where two or more particle size classes are found to increase efficacy of the active ingredient, several fractions are be mixed together in optimum proportions.

### CROSS REFERENCES TO RELATED APPLICATIONS

This application claims priority from U.S. Ser. No. 60/657,464, filed Mar. 1, 2005, the specification of which is incorporated herein by reference in its entirety.

### FIELD OF INVENTION

This invention relates to bioactive chemicals having increased activity for use in agriculture and the pharmaceuticals industry, which are obtained by modifying the statistical properties of their formulations.

### BACKGROUND OF THE INVENTION

Many formulations of bioactive chemicals, including pesticide and pharmaceutical formulations, consist of an active ingredient (AI) which is presented to a target organism or target site within an organism in particulate form, which may be either sold or liquid in capsulated or microencapsulated forms. Generally, within any such formulation there is a wide distribution of particle size. In the past, there has been little, if any, attention given to the importance of the particle size in such formulations.

Additionally, pesticide formulation application in agriculture and horticulture has historically been a very inefficient process (Graham-Bryce 1983). Estimates of the amount of pesticide sprayed actually reaching its intended target and resulting in pest mortality (application efficiency=delivery efficiency*biological efficiency) range from ˜1% for some broad-spectrum post-emergent foliar-applied herbicides (Graham-Bryce 1983) to <0.001% for many insecticides (Hall & Adams 1990). The fraction of insecticide spray, for example, landing on the target plant may exhibit spatial distribution that is sub-optimal for the desired biological effect, resulting in failure of the pest to accumulate sufficient insecticide for mortality (Hall Adams 1990). Of the insecticide acquired by the target, only a small fraction reaches the susceptible site within the organism (Ratcliffe & Yendol 1993, Ebert et al. 1999a, 1999b). A very large proportion of the unused pesticide enters the environment, contaminating the soil, water, or other non-target organisms via drainage, direct runoff, or drift. Not only is the excess pesticide wasted, it can contribute to the development of pesticide resistance (Roush 1989). Pest resistance to insecticides alone is documented in greater than 540 crop pests (MSU 2004), resulting in the loss of a large proportion of potential chemicals, particularly some of the more environmentally friendly products. As it costs greater than $50 million to develop and register a new chemical pesticide, the rapid development of resistance by pests adds substantially to the cost of pest control.

The vast majority of agricultural pesticides are delivered hydraulically through nozzles that break the fluid flowing through them into spray clouds that are deposited into and onto the crop canopy. For a given active ingredient (AI) the efficacy of the spray cloud may be influenced by the choice of nozzle, the choice of adjuvant(s), or a combination of the two (Chapple 1993, Chapple et al. 1993a, 1994). However, the choices of nozzle and/or adjuvant that maximize biological efficiency frequently increase off-target drift because biological efficiency and propensity for drift are both usually inversely proportional to droplet size. Also, small droplet spray clouds do not penetrate crop canopies well, so that even though the AI may be delivered in a more efficient drop size, it cannot reach the relevant parts of the crop. For this reason, AI must be applied in large droplets with concomitant waste of AI.

The biological efficiency of pesticides is influenced by two characteristics of the spray deposit on the foliage: deposit quantity (mass per unit area of foliage) and deposit quality (droplet size distribution and the spatial distribution of droplets on the foliage; Downer et al. 1998). Deposit quantity gives a rough guide to the distribution of the active ingredient (AI) within the canopy. However, a single 800 μm diameter droplet of a pesticide deposited on a leaf will not give the same biological result as the same volume deposited as 512 100 μm diameter droplets randomly or uniformly distributed on the leaf. Hence, deposit quality is a key component of the application process.

It is also well known that biological efficiency of insecticides is inversely proportional to drop size: small drops work better for the same amount of AI (Adams et al. 1990). A similar relationship exists for herbicides and fungicides. Thus, it should be possible to optimize the distribution of droplets on the plant to achieve a desired efficacy while reducing the total AI applied. There are three known ways this can be achieved: 1) by manipulating nozzle dynamics by choice of nozzle tips or atomization device, 2) by manipulating formulation characteristics through choice of adjuvant(s), or 3) a combination of the two. However, laboratory findings of a correlation between quality of deposit of pesticides and biological efficiency are not supported in the field (Graham-Bryce 1983, Hislop 1987). In fact, the same amount of AI (deposit quantity) is usually required with small droplets as with large to achieve the same degree of control in the field (Arnold et al. 1984a,b,c). Major causes of reduced efficacy of small droplets in the field are drift and poor canopy penetration, both of which are also inversely proportional to droplet size. Thus, overdosing is always necessary because of the need to use large droplets to obtain adequate canopy penetration and to minimize drift. Such overdosing may be mandated by regulations specifying the use of high volume nozzle tips to minimize drift.

The proper understanding of pesticide delivery and acquisition required for improving application efficiency has been hampered by the complex, non-linear, and sometimes antagonistic nature of the process of dose-transfer. Dose transfer is the entire process from atomization of a biocide to biological effect. It includes atomization by the nozzle, transport to the target, impaction and retention, degradation and off-target fate of AI, dose acquisition and biological effect on the target. No analytically tractable theory of dose-transfer has been derived, although components have been investigated semi-analytically and numerically (Salt & Ford 1993, Chapple & Hall 1993, Chapple et al. 1993b, 1995).

### SUMMARY OF THE INVENTION

The present application provides new bioactive chemicals having increased bioactive activity and a method for manufacturing such materials. Specifically, the present application provides an optimum particle size or a small set of optimal particle sizes within the bioactive chemical materials in order to obtain increased activity of the active ingredient. The use of an optimum particle size is desirable, since if the distribution of particle sizes can be narrowed around these optima, the amount of active ingredient (“AI”) required for a specified biological effect may be reduced.

The present application provides that a formulation comprising a bioactive material in particulate form in which at least 50% of the particles by volume or mass are in the range 0.5M to 1.5M, where M is the most biologically active particle size class (i.e. the mode), where the number of size classes is at least 12 and preferably at least 20, such that the distribution can be characterized efficiently and the mode be well defined. More specifically, it is also preferred in an alternate formulation for such bioactive chemical materials that at least 90% of the bioactive material particles by volume or mass are in the range 0.5M to 1.5M, and 50% of the particles by volume or mass are in the range 0.75M to 1.25M. In such an embodiment, where two or more particle size classes are found to increase efficacy of the AI, several fractions may be mixed together in optimum proportions determined experimentally for the AI in question.

The present application also provides that with respect to the improved bioactive materials, it is not always necessary to find the optimum particle size before narrowing the particle size distribution. In this application, a number of narrowed particle size distributions covering a wide range of modal particle sizes may be used, all of which improve performance relative to the original particle size distribution. While not all fractions would show the same increase in efficacy when used against different targets, an increase in bioactivity would be seen, and one would simply need to determine the optimum particle size for a defined target to achieve the highest increases in bioactivity.

It is known to one of ordinary skill in the art generally, that bioactive chemicals are selected by bioassaying formulations milled using conventional means, and taking the formulation that provides the best biological result (e.g., greater mortality of insects or weeds, increased crop safety margin for a selective herbicide, greater reduction in plant height for a given dose of a plant growth regulator, herbicide safener, etc. for pesticides, and greater efficacy for medicines, antibiotics, drugs, etc.). Bioassays or field trial techniques for given classes of bioactive chemicals are easily found in the literature, for example the EPPO bulletins for agricultural pesticides, published by Blackwell Scientific Publications. Additionally, it should be understood that the meaning of the term “size” should include any convenient measurement of particle diameter, volume, or mass, and that the meaning of the term “class,” when used with respect to categorization of particle size, is intended to mean the interval or intervals within which observations regarding particle size fall, for example, greater than 10 to 12 micrometer diameter and greater than 12 to 14 micrometer diameter, are two adjacent particle size classes.

Using insecticides as one example of model systems to investigate the statistical properties of bioactive chemicals, the present application provides that bioactive chemicals whose particles fall inside the desired range have a greater activity than those whose particles fall outside the desired range. It should be understood that the term bioactive chemicals as used herein should at least include, pesticides (which includes fungicides, herbicides, insecticides and growth regulators), as well as pharmaceuticals. The present application also discloses that for some materials, efficacy is nearly independent of the mode, and the act of narrowing the frequency distribution increases efficacy. Until this application, any given pesticide or medicine applied in particulate form contained a significant proportion of particles that were either less active than the most active size class or contained an excess of AI. This means that if the bioactive chemical formulation has particles of size falling only within the ranges defined by the invention, the amount of AI chemical can be reduced to achieve the same result as previously obtained with a broader distribution of particle size. The unwanted particles that are separated off, using for example a cyclone separator system described in International Patent Application No. WO 99/42198, for a Cleaning Apparatus by Arnold & Arnold (1999), can be re-milled or treated in some other known way to obtain another material batch containing at least some particles of the desired size range and this material batch can be subjected to a further separation.

The frequency distribution of the conventional formulation would then be narrowed to obtain an improved bioactive chemical formulation using, for example, the cyclone separator system of the type previously described, and the proportion of AI reduction calculated. Again, the particles could be sorted using a cyclone separator of the type described in WO 99/42198, or other commercially available comparable devices.

An alternate approach is to use formulations where the AI is adhered to the surface of an inert particle (e.g. kaolin clay). The formulation is then fractionated into a range of narrower frequency distributions and these are tested to determine which frequency distribution shows the greatest biological effect. Then, taking the original inert carrier and fractionating the inert carrier to obtain a similar narrower frequency distribution, the loading of the AI on the optimally-sized particles can be changed to find the combination of particle size and AI concentration that gives the optimum biological efficacy.

The invention is particularly applicable to pesticide formulations (e.g. insecticides, acaricides, fungicides, herbicides, herbicide safeners, insect and plant growth regulators, and biological, both parasitic and toxic, pesticides) and especially those, where in the application stage, the pesticide can be in particulate form, such as a wettable powder (WP), suspension concentrate (EC), or pure active ingredient. The active ingredient must either have a low solubility in the carrier liquid (for agricultural purposes, normally water, but this can be other liquids, e.g. oils) or be formulated such that the majority of the AI remains in particulate form during application.

The present application also provides that an improved formulation where the particle size has been narrowed such that there are fewer smaller sized particles, also contains, on average, fewer total particles. One consequence of this reduction in total particle numbers is the reduction in the propensity for off-target contamination (drift) of sprayed pesticides. The small droplets in the spray cloud have a reduced probability of containing any particles of the bioactive material (pesticide, growth regulator, etc.). As the propensity to drift is, in part, inversely related to drop size, any reduction in the quantity of the bioactive material in the smaller drops will reduce drift.

In addition to agricultural and pharmaceutical bioactive materials, the invention also has applications to some semi-bioactive materials, such as in the food-processing industry where, for example, flavor is sometimes related to texture of ingredients such as chocolate, and in non-bioactive materials, for example, ceramic and metal powders such as are used in the materials and metallurgical industries.

### BRIEF DESCRIPTION OF THE DRAWINGS

FIG. 1 illustrates that particle size and concentration are nearly independent of one another and their effect on efficacy can be visualized as an ascending ridge, where the exact shape of the ridge will depend on the bioactive chemical material. Normally the relationship would be a sigmoid curve, but as shown here, it is a straight line for clarity. Deposits off the ridge are generally inefficient and wasteful, as well as potential liabilities. Bioactive material products with deposits high on the ridge require less chemical for the desired biological result.

FIG. 2a is a graph showing a number distribution of particles by size for a narrowed distribution of a bendiocarb WP formulation (80% AI), with the mode at 13.7 μm compared with 11.4 μm for the original OEM formulation. The relative span of the formulation was 1.84, compared with 2.90 for the original formulation.

FIG. 2b is a graph showing a number distribution of particles by size for a narrowed distribution of a bendiocarb WP formulation (80% AI), with the mode at 19.7 μm compared with 11.4 μm for the original OEM formulation. The relative span of the formulation was 1.81, compared with 2.90 for the original formulation.

FIG. 3 is a graph showing the effect of altering particle size and width of frequency distribution on the time to kill 90% (KT90) of mosquitoes (Culex quinquefasciatus) on ceramic tiles using the original OEM bendiocarb (Ficam WP80) formulation and small, medium, and large extended particle (“EP”) size fractions, respectively.

FIG. 4 is a graph showing the dose-mortality curve for southern corn rootworm (Diabrotica undecimpunctata) treated with fipronil (Regent WG 80) and a derived EP in a soil bioassay shows a large shift to the left and a steepening of the response curve, indicating the increased activity of the EP relative to the original OEM formulation. Note the logarithmic dose scale.

FIG. 5 is a graph showing the percent mortality of army worm larvae (Spodoptera exigua) exposed to a small EP formulation and the original OEM deltamethrin (Decis WP80) formulation over a 10 day period.

FIG. 6 is a graph showing the dose-mortality curve for diamondback moth (Plutella xylostella) treated with deltamethrin (Decis WP 80) and a derived EP applied foliarly shows a large shift to the left of the response curve, indicating the increased activity of the EP relative to the original OEM formulation. Note the logarithmic dose scale.

### DETAILED DESCRIPTION OF THE EMBODIMENTS

The present invention is best illustrated by describing the application of the principles disclosed here in connection with three original insecticide formulations, or bioactive chemical materials, with different modes of action (a carbamate, a fipriole, and a pyrethroid) against seven species of insect. To illustrate the invention, five species were challenged with one bioactive chemical. The species used represent three important insect orders: Diptera (flies), Coleoptera (beetles) and Lepidoptera (moths). The trial environments ranged from ceramic tile and leaf surfaces in the laboratory, to leaf surfaces in the greenhouse, to soil incorporation in the field. The range of targets, substrates, and environments and the magnitude of the responses illustrate the availability of the application to various bioactive chemicals having active ingredients. The following description uses these examples of insecticides, used in the fields of vector control and crop protection as a model system which would likewise be representative of all classes of pesticides, and obvious analogs with antibiotics and other pharmaceuticals.

There are currently only three ways to increase application efficiency: 1) increase delivery efficiency, 2) biological efficiency, or 3) both. Because application efficiency is limited by the inverse relationship between delivery and biological efficiencies, significant increases in application efficiency are possible only if either or both can be decoupled from droplet size. Thus, selection of the bioactive material formulation chemistry by manufacturers and choice of nozzles and/or adjuvant(s) by applicators can only increase application efficiency incrementally. Decoupling delivery and biological efficiencies requires a radically new approach to delivery and/or formulation technology.

The development of a sprayer that severs the inverse connection between delivery and biological efficiencies provides a useful application tool. The sprayer separates the physical and biological requirements of the spray cloud by placing AI only in the biologically active small droplets while retaining the large droplets required to give the cloud sufficient kinetic energy to reach the canopy. This sprayer device, the Double Nozzle (Taylor & Chapple 2002), of the type disclosed in U.S. Pat. No. 6,375,089, resulted from studies of the dose-transfer process. The application efficiency of the Double Nozzle sprayer is at least double that of conventional delivery systems. Using the Double Nozzle, growers need use only 50% the normal quantity of AI/acre without compromising efficacy and in many cases increasing efficacy.

Study of the dose-transfer process also showed that there is an optimum drop size for deposits on the substrate. Large droplets are clearly inefficient, something success of the Double Nozzle confirms. But exceedingly small deposits, besides being highly drift-prone, were also shown not to deliver enough material for the desired level of efficacy, potentially resulting in a sub-lethal dose leading to resistance by the target to the chemical. A plot of mortality per unit AI against droplet size is approximately quadratic with the mode at the optimum droplet size.

Simultaneously, there is a dose-mortality response associated with the intrinsic toxicity of the material. These factors are nearly independent of one another and can be visualized, as shown in FIG. 1, as a ridge defining efficacy which is normally a sigmoid curve but is shown here as a straight line for clarity. The waste represented by applying large particles (left end of the x-axis in FIG. 1) is an immediate cost to crop protection and vector control; the waste occurring as a result of applying very small particles (the origin in FIG. 1) is a long-term cost as it is one of the sources of resistance development by targets receiving sub-lethal doses. The parallel with the development of resistance by disease organisms to antibiotics and other drugs is obvious.

The way to produce near-monodispersed deposits using a conventional hydraulic spraying system is to formulate a water insoluble AI as solid particles (a powder) and separate out the optimum size class. The narrower the size distribution of the optimum size class, the more will be in the larger than optimum size class and the less wasted. Furthermore, the absence of very small particles from the optimum size class will necessarily reduce the amount of driftable AI and sub-lethal doses. The term “particulates” provides a definition for the manufacturing approach to optimize pesticide particle sizes, which is also referred to herein in the product as an “extended powder” (“EP”). The link between the Double Nozzle (optimizing the frequency distribution of droplets carrying the AI) and particulates (optimizing the particle size distribution within a deposit) is clear.

The underlying principle behind both the Double Nozzle and particulates technology is the concept of decoupling the biological and delivery efficiencies in spray application. Decoupling delivery and biology permits the independent optimization of delivery and biological efficiencies of both subsystems. The former does this during application by separating the physics of the delivery system from the biology of the toxin acquisition process. By contrast, the particulates technology separates the physics from the biology during the manufacturing process. This practice is limited to water insoluble active ingredients, whereas the Double Nozzle works equally well with soluble and insoluble actives. Simulations supported by the results shown in the examples below, suggest rate reductions in excess of 85% for particulates compared to 50-75% rate reductions with the Double Nozzle.

The use of the term “particulates technology” as set forth herein, is used to reference the novel approach of this application, that seeks to improve the performance of water insoluble AIs by narrowing the frequency distribution of the particles present in the formulation. For foliar applied AIs, <5% of the AI should be soluble in the spray tank and for soil application <1% should be soluble. In one sense, “particulates” is an extension of wettable powder (WP) or suspension concentrate (SC) formulations, and as such, we refer to the resulting formulation as an “extended powder” or EP formulation. The essence of EPs is that they are formulations in which the size distribution of particles is optimized and narrowed. Particles which are smaller than the optimum may cause under-dosing, while particles larger cause overdosing and/or wastage. The relationship between particle size (diameter) and the amount of AI present in a particle (volume or mass) follows a cube function, so that any reduction in the number of larger-than-optimum particles would lead to substantial savings in the amount of AI required for a given biological effect. Also, other effects, such as acceleration of effects, widening selectivity, and slowing the rate of resistance acquisition may also be possible.

The use of the spray applicators, such as a Double Nozzle system, reduces application rates by at least 50% by capitalizing on the efficacy of small deposits and the necessity for large droplets in the spray cloud to achieve satisfactory delivery of AI to the target. The Particulates concept takes the principle a step further. Large deposits (and therefore large droplets) of AI are clearly inefficient and wasteful as are exceedingly small deposits because they are contained in small droplets and are highly drift-prone. In addition, small deposits do not deliver enough material to the substrate for the desired level of efficacy. These facts suggest, and are confirmed by simulation and experiment, that there is an optimum size for deposits: a plot of mortality per unit AI against deposit size is roughly quadratic with a maximum at an intermediate deposit size (see FIG. 1).

In practice, droplets and deposits cannot be made to be exactly a certain size; typically they are approximately lognormally distributed (Aitchison & Brown 1957). The particulates approach extends the Double Nozzle principle by narrowing the size frequency distribution and reducing the coefficient of variation. One aspect of narrowing the particle size frequency distribution is the reduction in the number of small particles. It is intuitively clear that one consequence is a change in the loading of the drops most prone to drift.

Because particulate formulations reduce the application rate by lowering the frequency of the inefficient ultra-fine and very large particles that contribute to drift and waste, respectively, the density of particles in the spray tank is also reduced. This ensures that the probability of particulates being sampled by small drift-prone droplets is reduced. In addition, a reduced application rate implies reduced off-target drift further reducing drift. One aspect of substantially narrowing the particle size frequency distribution is the reduction in the number of particles present, through the removal of many of the small particles. It is clear that one consequence is a change in the loading of the drops most prone to drift. If the drops produced by the atomizing system are considered to be a sampling system, then one can easily calculate the probability that a given drop will contain no AI, using the number of particles present in the spray volume and the volume of the various drops. It is clear that if there are fewer particles, then any given drop will have a smaller chance of capturing one or more particles of AI.

The above assumes that the frequency distribution of the particles of AI remains the same; only the mode changes. In practice, this is not the case: the cube function relationship between diameter and volume means that the relationship is non-linear. For example, if the particles of AI were monodispersed (all the same size), then an increase by a factor of two in the particle diameter would give an eightfold reduction in number of particles, with each particle containing eight times the AI. Taking a non-monodispersed (the real world situation) distribution, the shift of the particle size distribution from a mode of Xμm diameter to 2×μm, will result in even fewer particles as the larger particles in the new distribution are not only very much larger, but also very much rarer. Taking the drops in the spray cloud as a sampling system, again for a monodispersed spray, no difference in loading of the different drops would be seen. However, the distribution of drop size in real spray clouds is skewed to the right (the lognormal distribution is a good model), thus the probabilities that a drop will contain more or less AI depend on the size frequency distribution of the AI particles in the spray tank. Clearly, there is an advantage to be gained: with fewer particles of AI available for the spray to sample, more of the smallest drops will contain either a greatly reduced share or no AI, simply as a function of their probability of sampling a volume with no AI present.

Given the volume of AI (α) and volume of carrier fluid (φ) in the tank, the volume of AI per unit volume of mixture is α/(α+φ)=ρ. Assuming good mixing so that the AI in the tank is not aggregated, the probability of a droplet of size 8 containing n particles is given by the terms of the Poisson series:
P(n)=μⁿ·exp(−μ)/n!
where μ=δρ for monodispersed particles. For non-monodispersed particles each size class (δᵢ, i=1 . . . k) must be computed separately. For each particle size, the probability is calculated for the likelihood of the various drop sizes to contain 1, 2, . . . n particles. Repeating this procedure for each particle size a matrix is built up that gives the number distribution of droplets of each size class containing particles of all size classes smaller than the droplet size. Integrating the number of particles across all particle sizes gives the loading for that drop size. The procedure is repeated for each drop size, and the resulting set of matrices combined to give the amount of the AI present in every AI particle size class in each drop size class. These calculations may be made using any available computer program or programming language.

Using this computer program, the pesticide loadings of driftable droplets were calculated for a commercial formulation of the bioactive chemical material, bendiocarb (Ficam® WP80, Bayer CropScience) and three extended powders (EPs) (termed Large, Medium, and Small) obtained from Ficam WP80 using a cyclone separator system. Drift results and particle sizing statistics are given in Table 1. D₁₀, D₅₀, and D₋₀, are standard measurements for particle sizing and correspond to the particle diameter of the 10, 50 (median) & 90 percentiles of the particles in the sample. The relative span is an estimate of the width of the distribution and is given by (D90−D10)/D50.

Comparisons of the different size fractions of EP formulations were made with the parent WP formulation. The volumes of AI contained in driftable-size droplets are easily determined by numerical integration of the density surfaces. The total driftable AI can then be expressed in mg/g applied, as shown in Table 2. As a preliminary investigation to guide further experimentation, as described in the Examples below, the original product formulation or OEM formulation product, and three fractions of of Ficam were used in simulations of the computer program using a Pesticide Droplet Simulator model (Taylor et al. 1993, available from The Ohio State University, Department of Entomology, Wooster, Ohio) to determine the smallest amount of insecticide needed to kill 95% (LD95) and the time required to kill 95% (KT95) of simulated mosquitoes walking on a treated surface. For these simulations, the simulated insects walked on the surface with feeding switched off and toxin acquisition set to contact.

Another novel principle employed by particulates technology approach is the idea of using the atomizing system as a sampling system in which it is possible to calculate the probability that a given drop will contain no AI or AI particles of a defined size. It is clear that for a given particle size the fewer particles that are present, the smaller their chance of being captured by droplets of any defined size. By reducing the number of small particles, we reduce the chance they will be sampled by drift-prone small droplets. Thus, the particulates approach to pesticide formulation not only reduces the amount of AI required for pest control, it also reduces off-target drift. It should be noted that this drift reduction property is essentially independent of choice of nozzle—it is strictly a function of formulation. Thus, use of particulates technology is fully compatible with application by the Double Nozzle. In fact, because the Double Nozzle obtains its increased efficiency by improving delivery and particulates by improving biological efficiency by facilitating acquisition, we expect a synergistic effect when the two technologies are combined.

### EXAMPLES

1. Bendiocarb

Bendiocarb was tested as three separated fractions (Small, Medium, and Large fraction EPs) of the parent Ficam WP80 (Bayer CropScience) formulation, using ceramic tiles as a surface and the mosquito vector Culex quinquefasciatus as a test organism. Four doses were tested—recommended “field” rate, half, quarter, and an eighth dose. The distributions of the original WP80 and the three fractions produced are given in Table 1.

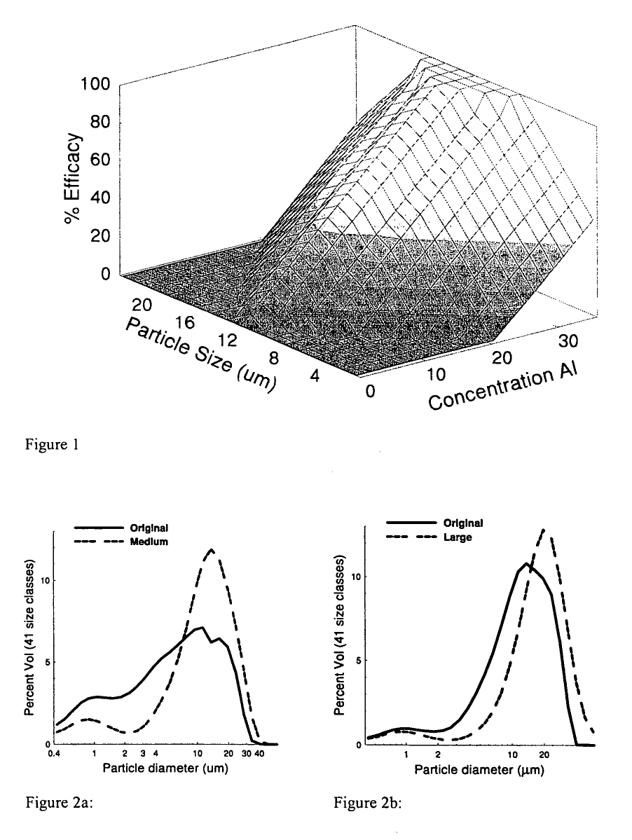

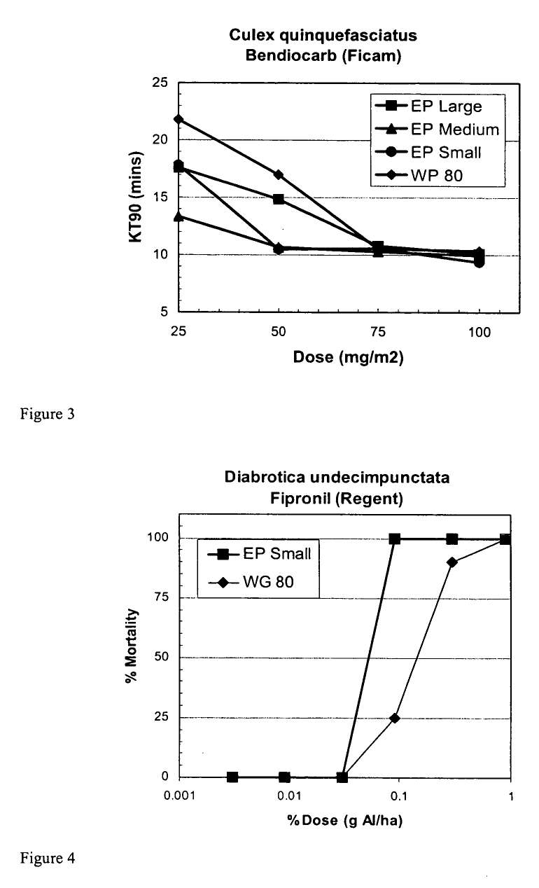

When bendiocarb was presented to mosquitoes as a residual deposit of either the conventional commercially available formulation (Ficam WP80) or the formulation where the particle size frequency distribution has been narrowed (EP), the narrowed frequency distribution has a greater biological efficacy than the original WP80 formulation. Furthermore, this is independent of whether or not the mode was reduced. The mode of the Medium fraction EP was the same as that of the WP80 original or parent formulation, as shown in FIG. 2a, whereas the mode of the Large fraction EP was reduced, as shown in FIG. 2b. In both fractions, it is the action of reducing the width of the distribution that increased the activity of the insecticide. As dose level is reduced from 100 mg/m² to 75, 50, and then 25 mg/m², the narrowed particle size formulations had significantly faster time to knockdown of 90% (KT90), as best shown in FIG. 3, of the mosquitoes than the original WP80 formulation. Narrowing the particle size distribution accelerated the rate of knockdown relative to the original formulation results in the same biological result with the EPs at one-quarter the dose required using the original Ficam WP80 formulation.

This result is not a short term effect as evidenced by the knockdown and mortality data at a simulated three months ageing of the tiles. With artificially aged tiles (tiles kept at 54° C. for 2 weeks post application prior to bioassay), no mortality was observed with the Ficam WP80, whereas varying levels of mortality were obtained with the EPs (Table 3). Thus, efficacies of EP formulations have greater longevity than the parent WP. The improvement in mortality is of great interest from the point of view of vector control because it could make bendiocarb commercially competitive as a vector control product.

2. Fipronil

Three fractions of fipronil were separated from Regent 80WP (BASF) using the Vortak cyclone separator system. The smallest fraction was then reprocessed and separated into Fine and Small fractions.

A standard long lasting efficacy field trial was run using six rates of the two smallest fractions and the original parent WP80 against southern corn rootworm (Diabrotica undecimpunctata). Soil was treated with fipronil parent WG80 and EPs and Diabrotica eggs were introduced to the treated soil the day of treatment (0 DAT) and 21 days after treatment (21 DAT). Survival of Diabrotica was assessed 14 days later[0047]

The results are given in Table 4 which shows standard dose-mortality parameters (DL50, LD95, and LD99). The important data are the comparison between the EP Small and the parent WG80 formulations also shown in FIG. 4. Note the logarithmic dose scale, which gives the proportionate difference between treatments. At 21 days after treatment (DAT) there was a significant 3- to 5-fold increase in efficacy. Examination of mortality immediately after application (0 DAT) showed little difference between the EP Small and WG80, but by 21 DAT the dose-mortality curve for the Small EP remained unchanged, whereas the curve for the parent WG80 is less steep and is shifted to the right, as seen in FIG. 4, resulting in the higher LDs for the WG80, shown in Table 4. Thus, higher doses are needed to obtain the same efficacy over time with the WP. These results confirm that the improvement in performance of EPs is due to the acceleration of effect by formulations with optimized particle sizes.

3. Deltamethrin

Four fractions of deltamethrin were separated and sized (Table 1). In a preliminary experiment all fractions were compared with the parent Decis WP80 (Bayer CropScience) in a trial with armyworm larvae (Spodoptera exigua). The procedure was similar to bendiocarb except application was by track sprayer onto cotton leaf disks. The results were the same as with bendiocarb: a more rapid knockdown was obtained with lower rate than the parent WP80. Results for the Small EP versus the WP80 are shown in FIG. 5.

To test the generality of this result, trials were also run of deltamethrin against larvae of three moths (Plutella xylostella, Heliothis armigera and Spodoptera frugiperda), and larvae of a beetle, (Phaedon cocheariae). These were greenhouse trials in which plants infested with the target insects were sprayed with the parent and the Small EP fraction at seven rates using a hand sprayer. Efficacy was assessed at 3 DAT.

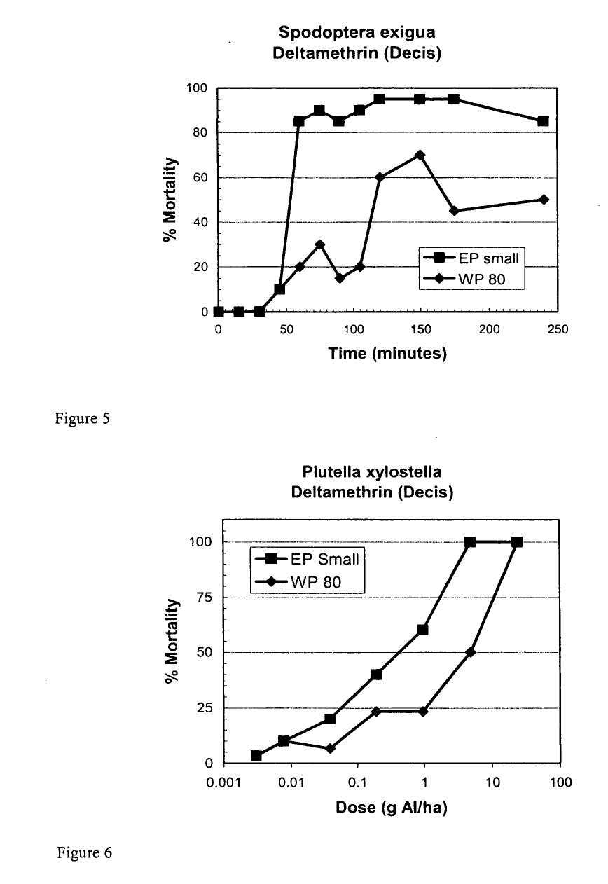

The dose-mortality curves for Plutella xylostella are given in FIG. 6. The dose mortality parameters (DL50, LD95, and LD99) for all targets are given in Table 4. They show clear separation between the EPs and parent WP80. The dose is again in logs, so that the separation between the curves represents increases in activity of the EP of at least 4-fold.

A Method of Manufacturing an Improved Bioactive Chemical

The first step in using the particulates technology in the areas of pesticide and pharmaceutical production is to determine the optimum particle size of the bioactive chemical for the required biological effect. This will be achieved by challenging the target insect, weed, pathogen, or disease agent with formulations of the chemical with different-sized particles. These different-sized particle fractions will have narrowed distribution of particle sizes around selected modal sizes. The fractions will be separated by a conventional method, such as by using a cyclone separator system, tested in standardized laboratory, greenhouse and field trials, such as those described herein. Having identified one or a small number of optimum particle sizes, this information will be used in the production and formulation process of the bioactive chemical.

Manufacturing and synthesis of optimized bioactive chemicals will generally by the same using the particulates process as currently used for non-optimized solid formulations of bioactive chemicals.

Particulates technology will be applied in practice by inserting a stage following chemical manufacturing or synthesis, which precedes product packaging. This stage will separate from the manufactured bioactive chemical, the optimized particle size identified in the preceding method. Machinery for implementing this will be similar to that used in the preceding method, but of a scale suitable for manufacturing adequate quantities of the improved bioactive chemical. The quantity deemed adequate will be determined by consideration of the size of the market and the volume of material required to serve that market.

Application of optimized bioactive chemicals will be the same using the particulates process as currently used for non-optimized solid formulations of bioactive chemicals. In agriculture this will include, but not be limited to, boom sprayers, including boom sprayers equipped with a Double Nozzle, electrostatic, air assist, and spinning disk sprayers; also aircraft-mounted sprayers, small sprayers utilizing all terrain vehicles such as are used on golf courses, greenhouse integrated spraying systems, and hand held sprayers, both powered and non-powered. In vector control aircraft-mounted sprayers, boom sprayers, and hand sprayers, powered and non-powered, will also be used as they are now with non-optimized bioactive chemicals. In the area of drugs, antibiotics, and other pharmaceuticals, application will be also be closely similar to current practices.

Using the present invention, particulates-formulated active ingredients (EPs) have increased efficacy relative to their original or OEM product formulations. These effects can be seen in FIG. 4 as a steepening of the dose-mortality curve and/or a shifting, as seen in FIG. 6, of the dose-mortality curve to the left, relative to the original product formulation. These changes in the dose-mortality relationships brought about by optimizing the particle size distributions act in two ways, as an acceleration of the rate at which a given result can be obtained and as a true reduction in the amount of active ingredient required for a given biological effect. While the results shown are for insecticides, such bioactive chemical material formulations are representative of results of optimizing the size distributions of whole classes of other bioactive materials, including other pesticides and pharmaceuticals. Additionally, while various embodiments of the invention have been described in detail herein, it will be appreciated by those skilled in the art that various modifications and alternatives to the embodiments could be developed in light of the overall teachings of the disclosure. Accordingly, the particular materials and arrangements are illustrative only and are not intended to limit the scope of the invention which is to be given the full breadth of any and all equivalents

TABLE 1
Frequency distribution statistics for bendiocarb 80% WP, fipronil 80% WG and
deltamethrin 80% WP and separated EP fractions.

| | | | | | |
|---|---|---|---|---|---|
| Size Statistic | Original WP | Fine fraction | Small fraction | Medium fraction | Large fraction |

Bendiocarb (Ficam WP80)

| | | | | | |
|---|---|---|---|---|---|
| Mode | 11.4 μm | — | 3.8 μm | 13.6 μm | 19.6 μm |
| D10 | 0.89 μm | — | 0.76 μm | 1.8 μm | 6.1 μm |
| D50 | 5.9 μm | — | 2.6 μm | 10.8 μm | 17.3 μm |
| D90 | 18.0 μm | — | 6.8 μm | 21.6 μm | 37.6 μm |
| Relative Span | 2.90 | — | 2.33 | 1.84 | 1.81 |

Fipronil (Regent WG80)

| | | | | | |
|---|---|---|---|---|---|
| Mode | 6.4 μm | 6.1 μm | 6.5 μm | 7.0 μm | 7.0 μm |
| D10 | 0.64 μm | 0.63 μm | 0.39 μm | 0.66 μm | 0.64 μm |
| D50 | 2.2 μm | 1.9 μm | 1.8 μm | 2.4 μm | 2.3 μm |
| D90 | 10.8 μm | 9.1 μm | 7.4 μm | 11.8 μm | 12.1 μm |
| Relative Span | 4.62 | 4.44 | 3.83 | 4.65 | 5.03 |

Deltamethrin (Decis WP80)

| | | | | | |
|---|---|---|---|---|---|
| Mode | 2.6 μm | 1.1 μm | 1.3 μm | 3.2 μm | 3.0 μm |
| D10 | 0.64 μm | 0.39 μm | 0.63 μm | 0.66 μm | 0.64 μm |
| D50 | 2.2 μm | 1.8 μm | 1.9 μm | 2.4 μm | 2.3 μm |
| D90 | 10.8 μm | 7.4 μm | 9.1 μm | 11.8 μm | 12.1 μm |
| Relative Span | 4.62 | 3.83 | 4.44 | 4.65 | 5.03 |

TABLE 2
Results of computations using size distributions of bendiocarb Ficam
WP80 parent and three optimized EP fractions show that optimizing
the particle size distribution can reduce the susceptibility to
off-target drift of pesticides by altering the droplet loadings of
the most drift-prone droplets in a spray cloud.
Amount of driftable bendiocarb

| WP80 | EP Small | EP Medium | EP Large |
|---|---|---|---|
| 52 mg/g | 37 mg/g | 35 mg/g | 23 mg/g |

TABLE 3
Mortality of mosquitoes (Culex quinquefasciatus) exposed to
bendiocarb (Ficam WP80) treated ceramic tiles aged for 2 weeks at
54° C. post-treatment.

| | |
|---|---|
| Dose | % Mortality |

| (mg/m²) | WP80 | EP Large | EP Medium | EP Small |
|---|---|---|---|---|
| 100 | 0 | 7.5 | 50.7 | 100 |
| 75 | 0 | 6.3 | 39.6 | 60.9 |
| 50 | 0 | 0 | 0 | 94.4 |
| 25 | 0 | 0 | 0 | 21.3 |

TABLE 4
Dose-mortality statistics for fipronil (Regent WG80) show a nearly
five-fold decrease in dose of the EP Small fraction required to kill
90-99% of southern corn rootworm (Diabrotica undecimpunctata)
in a soil bioassay. Dose-mortality statistics for foliar applications of
deltamethrin (Decis WP80) against three moths (Plutella xylostella,
Spodoptera frugiperda, and Heliothis armigera) and a
beetle (Phaedon cochleariae) show large increases in activity
of the extended powder (EP Small) over the parent WP80.

| Target | Form | LD50 | LD90 | LD95 | LD99 |
|---|---|---|---|---|---|
| D. undecimpunctata | WG80 | 0.135 | 0.299 | 0.375 | 0.572 |
| | EP Small | 0.047 | 0.072 | 0.081 | 0.101 |
| Increase in activity of EP | | 2.87 | 4.15 | 4.63 | 5.66 |
| P. xylostella | WP80 | 1.882 | 101.2 | 313.2 | 2606 |
| | EP Small | 0.232 | 4.315 | 9.889 | 46.83 |
| Increase in activity of EP | | 8.1 | 23.4 | 31.7 | 55.6 |
| S. frugiperda | WP80 | 0.250 | 9.106 | 25.25 | 170.9 |
| | EP Small | 0.052 | 0.811 | 1.769 | 7.651 |
| Increase in activity of EP | | 4.8 | 11.2 | 14.3 | 22.3 |
| H. armigera | WP80 | 2.251 | 63.64 | 164.2 | 970.6 |
| | EP Small | 0.373 | 9.441 | 23.61 | 131.6 |
| Increase in activity of EP | | 6.0 | 6.7 | 6.9 | 7.4 |
| P. cochleariae | WP80 | 0.542 | 8.863 | 19.57 | 86.45 |
| | EP Small | 0.103 | 0.766 | 1.355 | 3.948 |

| | | | | |
|---|---|---|---|---|
| Increase in activity of EP | 5.3 | 11.6 | 14.4 | 21.9 |

1. An improved bioactive chemical having an active ingredient with increased bioactivity where the particulate form of the bioactive chemical has at least 50% of the particles by volume or mass in the range of 0.5M to 1.5M, where M is the most frequently obtained particle size class and selected to be the optimum size class, where size is taken as any convenient measurement of diameter, volume, or mass, and where the number of particulate size classes is at least 12.

2. The improved bioactive chemical of claim 1, wherein the number of particulate size classes is at least 20.

3. The improved bioactive chemical of claim 1, wherein the particle size has a distribution which is narrowed around a predetermined optimum particle size or mode, and has a substantially more symmetric particle size distribution than an original formulation of the improved bioactive chemical.

4. The improved bioactive chemical of claim 1, wherein the particle size has a narrow, approximately normal distribution.

5. An improved bioactive chemical containing an active ingredient with increased bioactivity, wherein said active ingredient includes particle sizes within an optimized particle size distribution and a lower number of large and small wasteful particles.

6. The improved bioactive chemical as in claims 1 or 5, wherein said bioactive chemical is a pharmaceutical formulation, or a pesticide formulation, including an insecticide, herbicide, fungicide, growth regulator or safener formulation.

7. The improved bioactive chemical of claims 1 or 5, wherein said bioactive chemical is a non-biological material or semi-biological material.

8. A method for manufacturing an improved formulation for a bioactive chemical material having an active ingredient(s) comprising the steps of:
a) determining the optimal particle size of the active ingredient in an original formulation for a bioactive chemical material according to particle size classes; and
b) selecting the optimal particle sizes of the active ingredient from the original formulation for the bioactive chemical using conventional separation and collecting techniques and equipment.
